(19) United States
(12) Patent Application Publication
(10) Pub. No.: US 2002/0098316 A1
(43) Pub. Date: Jul. 25, 2002

(54) Multilayer foil insulation and method for manufacturing

(76) Inventor: Richard M. Butler, Canton, MI (US)

Correspondence Address: REMY J. VANOPHEM, P.C., 755 W BIG BEAVER ROAD, SUITE 1313, TROY, MI, 48084, US

(21) Appl. No.: 09/769,909

(22) Filed: Jan. 25, 2001

(51) Int. Cl. B32B 3/26

(52) U.S. Cl. 428/72; 428/76; 428/138; 428/178

(57) ABSTRACT

A multilayer foil insulation, and related method of manufacturing the insulation, that is used for dissipating heat and attenuating sound. Layers of foil are stacked in a spaced apart relationship, and include perforated layers and an imperforate layer adjacent to or sandwiched between the perforated layers. Each of the perforated layers includes a pattern of perforations that define a plurality of standoffs that extend from the perforated layers and that contact an adjacent layer, thereby defining insulating spaces therebetween and maintaining the spaced apart relationship. The perforations permit sound to enter the multilayer foil insulation, wherein sound is acoustically scattered as it passes into the multilayer foil insulation through the perforations and the imperforate layer acoustically absorbs the sound within the multilayer foil insulation. The perforated layers and insulating spaces therebetween also enable heat dissipation and insulation, and all the layers are crimped within a hem of a carrier layer.

### BACKGROUND OF THE INVENTION

1. FIELD OF THE INVENTION

The present invention generally relates to multilayer insulation composed of thin foil layers of material. More specifically, this invention relates to a combination heat and acoustic shield and a method of producing the same, wherein the shield is lightweight, simple in construction, and is effective for dissipating heat and for attenuating sound from a high heat, high noise source, such as an automotive exhaust system.

2. DESCRIPTION OF THE PRIOR ART

The prior art includes various types of multilayer foil insulation that is often used with motor vehicles. The insulation is often necessary to shield a motor vehicle passenger compartment from heat and noise generated and conducted by engine exhaust systems. Accordingly, such insulation may be generally attached to an underside of a floor panel of the motor vehicle, or may be more localized by being wrapped around an exhaust component, such as a catalytic converter.

For example, U.S. Pat. No. 1,934,174 to Dyckerhoff teaches use of a heat insulating body having a stack of crumpled metal foil sheets that lay unevenly upon one another to form insulating spaces therebetween. The metal foil sheets are disclosed as being so crumpled as to have a number of contacts with relatively large air spaces between the sheets. Dyckerhoff discloses that the metal foil sheets are crumpled by distorting them irregularly by hand or by giving them a regular, equivalent form by machine. The sheets are not necessarily interlocked to maintain the assembly before they are attached to a structural member. Dyckerhoff further discloses that a protective casing can be provided to protect the insulation from outside pressure, such as by an outside shell that is made of metal heavier than the metal foil sheets. Dyckerhoff discloses that it is not necessary that all of the sheets be crumpled and that an intermediate sheet remains flat. Finally, Dyckerhoff asserts that the insulating body has value as a sound insulation.

Dyckerhoff, however, fails to disclose any structural details in regard to the assertion of sound insulation, and therefore, it is not clear what Dyckerhoff actually teaches in this regard. Additionally, a problem with Dyckerhoff, and multilayer insulation in general, is that under operating conditions, air trapped between the layers will expand, thereby causing the insulation to balloon. Such ballooning can cause the sound insulation to break apart and lose its effectiveness, or become damaged from expanding into direct contact with a heat source. Accordingly, Dyckerhoff discloses no features for alleviating pressure that causes ballooning.

U.S. Pat. No. 4,037,751 to Miller et al. teaches use of a thermal insulation composite that is fabricated into structural forms for use in exhaust passages of helicopter rotor blades. Miller et al. disclose a thermal insulation blanket including first and second metal skins spaced apart from each other by a metallic mesh. The metallic mesh includes deformations therein for contacting the skin sheets in a spaced away manner to define fluid spaces between the skins. The deformations include dimples, corrugations, wires, or tubular mesh members. It is further disclosed that at least one of the skin sheets may be perforated with slots in order to vent the air spaces for alleviating pressure differentials across the insulation, and for providing expansion space for absorbing thermal growth.

Unfortunately, Miller et al. require use of a separate and distinct spacing layer in the form of a metallic mesh member. The metallic mesh must be corrugated or otherwise upset, and additionally must be perforated to provide slots therein.

U.S. Pat. No. 5,011,743 to Sheridan et al. teaches a thermal insulation pad for use as a heat reflecting shield as well as a heat sink for dissipating heat at a desired location. Sheridan et al. disclose that the pad has a plurality of layers of metal foil sheets forming a stack, wherein the layers are arranged one above another in a vertical direction. The metal foil sheets are spaced apart by a plurality of embossments extending from at least one of the metal foil sheets. The embossments are described as being depressions or bumps that extend integrally from one sheet and make point contact with another adjacent sheet.

Unfortunately, as depressions or bumps, the embossments of Sheridan et al. provide comparatively little compressive strength or rigidity in the vertical direction normal to the planes formed by the metal foil sheets. This is largely because the sidewalls of the embossments are oriented at an angle with respect to the planes of the metal foil sheets. Additionally, Sheridan et al. do not teach or disclose any specific features for attenuating sound in addition to the heat insulating capability of the insulation pad.

U.S. Pat. No. 5,424,139 to Shuler et al. teach a metal heat insulator and method of producing the same. Shuler et al. disclose that the insulator has thin metal sheets disposed generally one above the other in a spaced apart relationship. Separate and distinct metal separators are disposed between each pair of thin metal sheets for maintaining the spaced apart relationship. The metal separators are a non-woven, substantially open layer having upper and lower contact surfaces that enable surface contact between the metal separator and the metal sheets that is less than 30% of the planar area of the metal separators. The metal separators are disclosed as being twisted expanded foil sheets made by a relatively new method of simultaneously cutting, stretching, and bending a thin metal sheet in such a way as to produce vertically disposed mesh portions and twisted cut mesh portions connecting the vertically disposed mesh portions.

Accordingly, the invention of Shuler et al. involves a relatively new and complex process, and a separate and distinct mesh for spacing foil layers apart within a heat insulator. Additionally, Shuler et al. do not teach or disclose any features for attenuating sound.

Finally, U.S. Pat. No. 5,550,338 to Hielscher teaches use of a disposable, sound-absorbing thermal shield for acoustic and thermal insulating of vehicle floor parts. Hielscher discloses that the thermal shield is composed of aluminum and consists of a substrate sheet, an insulating layer, and a protective cover that are held together by crimping at marginal zones thereof. The substrate sheet is perforated and is specified to be 0.3 to 1.5 mm in thickness. The insulating layer is carried by the substrate sheet and is built from several plies of relatively thick material having open pored structure such as ceramic wool, aluminum meshwork, or Aerogels. The insulating layer is specified to be 5 to 15 mm in thickness. A porous foil is disposed between the several plies, as an interlayer of the insulating layer. The porous foil is perforated with a needle roll to form perforation protrusions to ensure that the porous foil does not rest flat on adjacent plies of the insulating layer. The protective cover, made of foil or a thin spray-coating of metal, is provided on either side of the insulating layer and is specified to be 30 m to 0.2 mm in thickness on the substrate side of the insulating layer, and 0.5 to 1.2 mm in thickness on the other side.

Regrettably, Hielscher specifies no less than five different layers of differing thickness (substrate, thin protective cover, insulating plies, foil between insulating plies, and thick protective cover), and specifies a relatively large overall thickness of no less than 5 to 15 mm, counting only the insulating layer.

Therefore, what is needed is a simpler, cheaper, recyclable multilayer insulation for dissipating heat and attenuating sound. Specifically, multilayer insulation is needed that includes multi-purpose perforations that pressure relieve the multilayer insulation, permit enhanced acoustic attenuation, and provide integral spacing features such that no separate and complex spacing layer is required, wherein the integral spacing features provide improved rigidity over prior art designs and provide spacing between layers of insulation with an unprecedented minimum of surface contact therebetween. Finally, multilayer insulation is needed that specifies fewer layers of different thicknesses and that is reduced in overall thickness.

### SUMMARY OF THE INVENTION

According to the present invention, there is provided a multilayer thermal and acoustic insulation and a method of making the same. The multilayer insulation is provided for dissipating heat and attenuating sound that emanates from a heat source such as an automotive exhaust system. Layers of foil are stacked one upon another in a spaced apart relationship to establish a stack of the layers. The stack includes perforated layers having perforations formed therein, and includes at least one membrane or imperforate layer adjacent to or sandwiched between the perforated layers. The perforations define a plurality of standoffs that extend in a direction normal from the perforated layer and contact an adjacent perforated or imperforate layer to maintain the spaced apart relationship and define insulating spaces or chambers between all of the layers. The perforations of the perforated layers enhance attenuation of sound and alleviate build up of air pressure within the insulation. The multilayer insulation acts to attenuate sound by acoustically scattering a sound mass through the perforations in each of the perforated layers and by acoustic absorption in passing through the insulating spaces and striking against the imperforate layer within the multilayer insulation. The perforations also vent heated and therefore expanding air that would otherwise be trapped between the layers of the stack. A carrier layer provides a rigid backing and assembly device for the multilayer insulation. The carrier layer includes a peripheral crimping area and all of the layers of the stack include a peripheral margin therearound. The peripheral crimping area of the carrier layer is crimped over the peripheral margins of the imperforate and perforated layers to form a hem for assembling the multilayer insulation.

The method of manufacturing the multilayer foil insulation according to the present invention involves the following steps. First, a stack of layers that includes the imperforate layer and at least one pair of the perforated layers including perforations therein is provided. The perforations establish standoffs that extend in at least one perpendicular direction from the perforated layer. Second, the layers are stacked in a spaced apart relationship such that the standoffs contact the adjacent imperforate layer to define insulating spaces or chambers therebetween and maintain a defined spaced apart relationship among all of the layers. The stack of layers are then die-cut into a predetermined peripheral shape. A carrier layer is provided and includes a peripheral crimping area therearound. The stack of layers is then assembled onto the carrier layer, such that a peripheral margin around the stack of layers coincides with the peripheral crimping area of the carrier layer. Adhesive may be applied between the peripheral crimping area of the carrier layer and the peripheral margin of the stack to assist in holding the multilayer insulation together. Finally, the peripheral crimping area of the carrier layer is crimped over the peripheral margins of the stack of imperforate and perforated layers to form a hem for assembling the multilayer insulation.

Accordingly, it is an object of the present invention to provide a simple, low cost heat and acoustic shield in the form of a multilayer insulation that is capable of dissipating and insulating against heat and that is capable of attenuating sound by acoustic scattering and absorbing.

It is another object to provide a method for manufacturing a simple, low cost thermal and acoustic shield.

It is yet another object to provide a multilayer insulation having stacked foil layers with relatively simple integral spacing features formed therein that provide minimal surface contact between the layers and that provide greater rigidity between the layers.

It is still another object to provide a multilayer insulation that is capable of attenuating resonant sound by scattering sound through perforations in the stack, trapping sound between layers of the stack, and by absorbing resonant sound that enters the perforations in the stack of layers, is absorbed by insulating spaces between the layers and strikes the imperforate membrane layer.

It is a further object to provide a multilayer insulation that is capable of relieving itself of pressure caused by expanding air between layers.

It is yet a further object to provide a multilayer insulation that requires relatively few different layers of differing thickness and that has a reduced overall thickness with respect to articles of the prior art.

These objects and other features, aspects, and advantages of this invention will be more apparent after a reading of the following detailed description, appended claims, and accompanying drawings.

### BRIEF DESCRIPTION OF THE SEVERAL VIEWS OF THE DRAWINGS

FIG. 1 is an exploded perspective view of a multilayer foil insulation according to the preferred embodiment of the present invention, with layers of the insulation shown peeled back from one corner for clarity;

FIG. 2A is a cross-sectional view of a portion of an assembled version of the multilayer foil insulation of FIG. 1;

FIG. 2B is a cross-sectional view of another portion of an assembled version of the multilayer foil insulation of FIG. 1; and

FIG. 3 is an enlarged partial perspective view of a retainer layer composed of expanded metal in accordance with an alternative embodiment of the present invention.

### DETAILED DESCRIPTION OF THE INVENTION

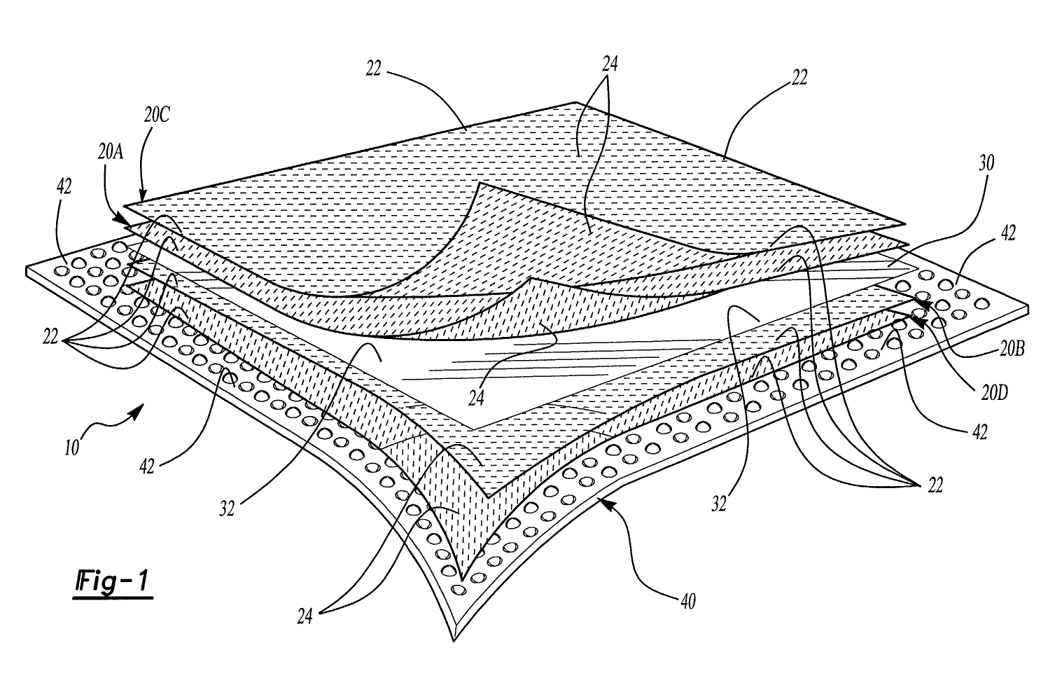

Referring now in detail to the Figures, there is shown in FIG. 1 an exploded, unassembled view of the multilayer foil insulation 10 of the present invention. The multilayer foil insulation 10 preferably includes a stack having four perforated layers 20A through 20D and a membrane or imperforate layer 30 sandwiched therebetween. All of the layers 20A through 20D, and 30 are stacked adjacent one another in a spaced apart relationship, but make point contact with each other in discrete places, as will be described below. Additionally, a carrier layer 40 provides rigidity and a mechanism for securing the layers 20A through 20D, and 30 together. The perforated layers 20A through 20D are preferably composed of an aluminum foil 0.050 mm in thickness and according to SAE 1100 AL, provided by Alcoa or Allfoils. The imperforate layer 30 is preferably composed of an aluminum foil approximately 0.025 mm in thickness. For purposes of making an experimental model, a foil wrapper from a Lindt brand chocolate product was used for the imperforate layer 30. The carrier layer 40 is also preferably composed of an aluminum 0.400 mm in thickness. Accordingly, the multilayer foil insulation 10 is 100% recyclable. Since the structure of the present invention is what is novel and unobvious, the multilayer foil insulation 10 could alternatively be composed of magnesium, steel, copper, tin, heat-resistant plastic, or any composite that is sufficiently resistant to the heat to which the multilayer foil insulation 10 is subjected.

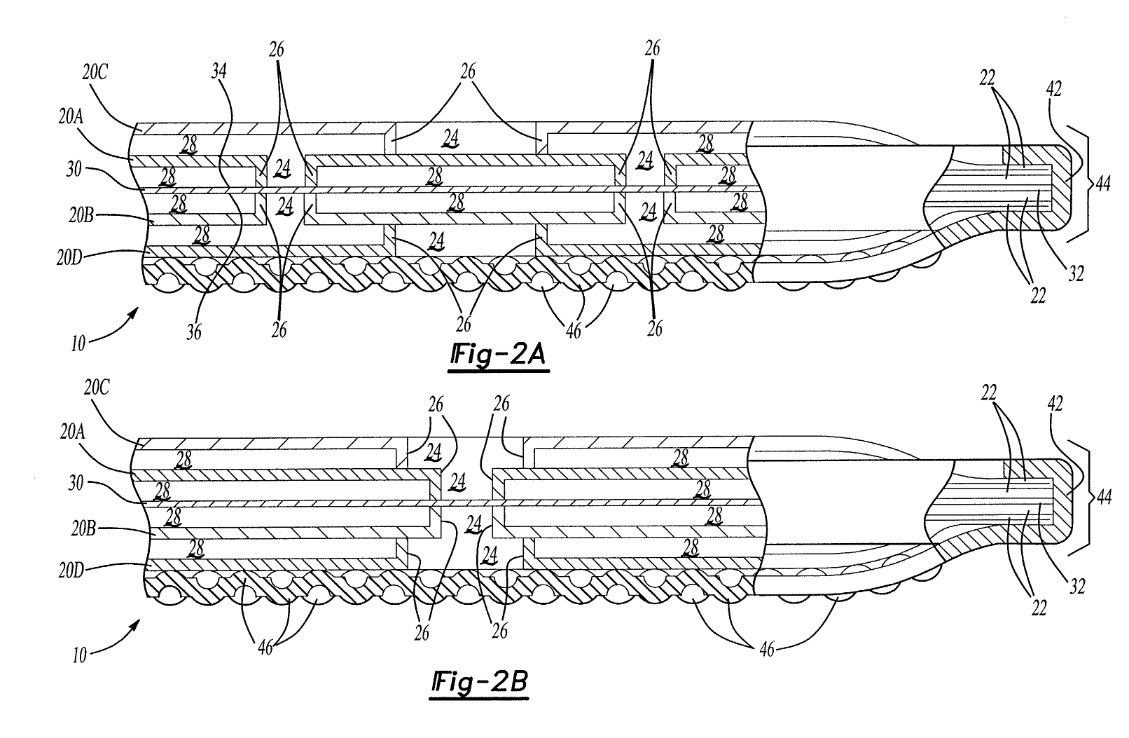

The carrier layer 40 includes a peripheral crimping area 42 therearound. Likewise, each of the imperforate layer 30 and perforated layers 20A through 20D have a peripheral margin 32 and 22, respectively, therearound for engaging the peripheral crimping area 42 of the carrier layer 40. The peripheral crimping area 42 of the carrier layer 40 is crimped over the peripheral margins 32 and 22 of the imperforate and perforated layers to form a hem 44 for assembling the multilayer foil insulation 10, as best shown in FIGS. 2A and 2B.

FIGS. 2A and 2B illustrate cross sections of two different portions of the multilayer foil insulation 10 of FIG. 1. The hem 44 is provided to fasten the perforated and imperforate layers 20A through 20D and 30 together and establish a completely assembled multilayer foil insulation 10. Additionally, an adhesive (not shown) may be used between the hem 44 and the peripheral margins 22 and 32 to further fasten and seal the multilayer foil insulation 10. The carrier layer 40 provides structural rigidity, and the hem 44 provides a robust area to use for attaching the multilayer foil insulation 10 to a surface on a vehicle, as is well known in the art.

Each perforated layer 20A through 20D includes a plurality of perforations 24 therethrough that are preferably arranged in a uniform pattern in each layer as shown in FIG. 2B. It is preferable that the perforations 24 overlap so as to permit communication of sound external to the multilayer foil insulation 10 to the imperforate layer 30. Additionally, the perforations 24 act to ventilate the multilayer foil insulation to preventing ballooning under operating conditions. For purposes of making an experimental model, a hand roller model RP-77 available from Robert Main, Inc., was used to perforate the perforated layers 20A through 20D. Preferably, however, the perforations 24 are slot-shaped approximately 1 by 2 mm in dimension. The perforations 24 of each adjacent layer overlap and extend transversely with respect to one another, such that the perforations 24 of adjacent perforated layers 20A through 20D are in communication with one another. The angle at which the perforations 24 of adjacent layers intersect is preferably 90°, but may vary.

As shown in FIGS. 2A and 2B, the perforations 24 are pierced into each perforated layer 20A through 20D and therefore define standoffs 26 that project from the perforations 24 in a direction normal to the perforated layer 20A through 20D. The standoffs 26 preferably all project in a direction centrally toward the imperforate layer 30, however, they may also extend in opposite directions from each perforated layer 20A through 20D. The standoffs 26 of a first perforated layer 20A and a second perforated layer 20B are respectively in contact with a first side 34 and an opposite side 36 of the adjacent imperforate layer 30. The standoffs 26 of a third perforated layer 20C are in contact with the first perforated layer 20A opposite the imperforate layer 30, and the standoffs 26 of a fourth perforated layer 20D are likewise in contact with the second perforated layer 20B opposite the imperforate layer 30. The standoffs 26 space the adjacent perforated layers 20A through 20D away from each other to form insulating chambers or spaces 28 therebetween and maintain the stack of perforated and imperforate layers 20A through 20D, and 30 in a spaced apart relationship. In this way, the multilayer foil insulation 10 of the present invention provides a superior device to dissipate the passage of heat therethrough.

Similarly, the carrier layer 40 includes a pattern of embossments 46 for minimal point contact with the fourth perforated layer 20D. The standoffs 26 of the perforated layers 20A through 20D and embossments in the carrier layer 40 are preferably about 1 mm in overall height.

In a typical automobile, heat readily radiates from an exhaust source to the passenger compartment in the absence of any thermal insulating devices disposed therebetween. Therefore, the multilayer foil insulation 10 is interposed as a reflective insulating device wherein the aluminum foil layers have very low emissivity and therefore initially reflect the heat radiation. Additionally, the multilayer foil insulation 10 acts as a bulk insulating device wherein the opacity of the aluminum foil layers 20A through 20D, 30, and 40 and the insulating spaces 28 therebetween act to resist transfer of heat therethrough. The heat radiation is absorbed by the third foil layer 20C and conducted thereacross and therethrough to an adjacent insulating space 28, between the first and third foil layers 20A and 20C. The heat is convected through the insulating space 28, and again absorbed by the first foil layer 20A, and similarly on through to the carrier layer 40 in diminishing intensity. Thus, the multilayer foil insulation 10 provides an excellent device to retard and dissipate the transfer of heat therethrough. Additionally, the perforations help prevent excessive ballooning of the multilayer foil insulation 10 assembly. Ballooning occurs when either trapped resonant sound or trapped expanding air act to increase the distance between each of the layers. Thus, the perforations provide a way for heated and expanding air to escape to mitigate the amount of ballooning.

In addition to heat, sound in the form of an integral sound mass also radiates from the exhaust component to a passenger compartment in the absence of an acoustic insulating device. Therefore, the multilayer foil insulation 10 provides an excellent shielding and quieting device to attenuate the propagation of sound therethrough. First, the third layer 20C of foil acts to reflect sound impinging upon the multilayer foil insulation 10. Second, the third layer 20C acts to absorb sound traveling therethrough. The perforations 24 permit sound to travel therethrough and enable the integral sound mass to be broken up into tiny sound points and acoustically scattered into the multilayer foil insulation 10. Primarily, however, the perforations 24 permit the sound to travel through the third and first layers 20C and 20A to the imperforate layer 30 for acoustic absorption thereagainst. Acoustic absorption occurs as a result of the sound mass being broken up through the perforations 24, being absorbed by the insulating spaces 28, and striking the imperforate layer 30.

Referring again to FIG. 1, the preferred method of manufacturing the multilayer foil insulation 10 according to the present invention involves the following steps. The multilayer foil insulation 10 is assembled by first layering the two perforated layers 20D and 20B, then layering the imperforate layer 30 thereover, and then layering the remaining two perforated layers 20A and 20C, thus forming a stack having a peripheral margin therearound. Each of the perforated layers 20A through 20D include the perforations 24 therein that define the integral standoffs 26 that extend away from each of the four perforated layers 20A through 20D toward an adjacent layer 20A through 20D, or 30. The imperforate and perforated layers 30 and 20A through 20D are stacked or layered in a spaced apart relationship such that the standoffs 26 contact an adjacent one of the perforated layers 20A through 20D or imperforate layer 30, to define insulating spaces 28 therebetween and maintain a spaced apart relationship. The stack of layers is then die-cut into a predetermined shape. The stack of layers 20,30 is further assembled onto the carrier layer 40, that also has a peripheral crimping area 42 therearound, by crimping the peripheral crimping area 42 of the carrier layer 40 over the peripheral margin of the assembled stack of perforated and imperforate layers 20A through 20D, and 30 to form a hem 44, as shown in FIGS. 2A and 2B, for retaining the multilayer foil insulation 10 together. Optionally, adhesive may be applied between the peripheral crimping area 42 of the carrier layer 40 and the peripheral margin 22,32 of the stack of layers.

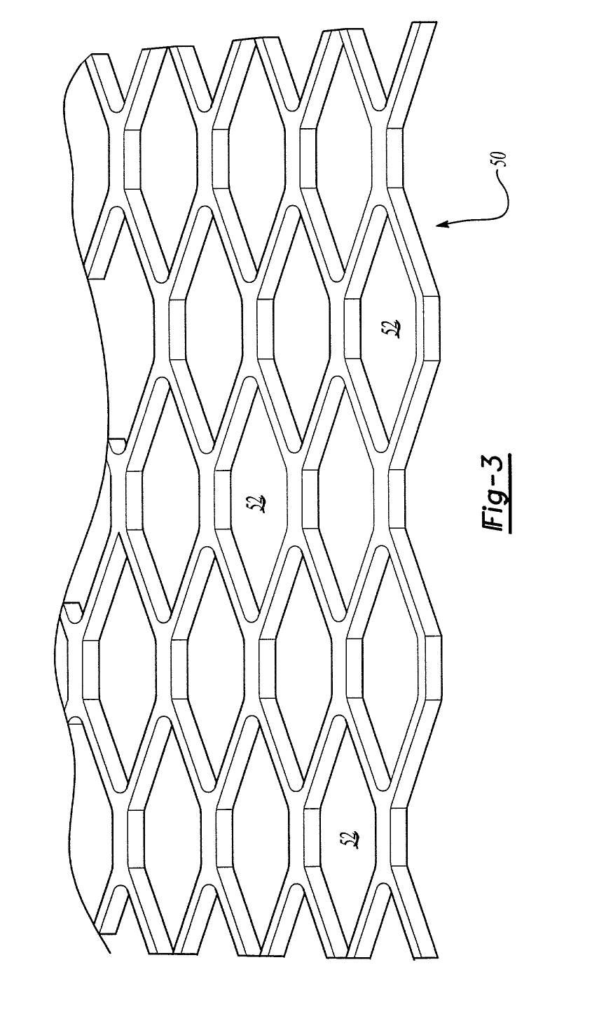

FIG. 3 illustrates a retainer layer 50 composed of expanded metal sheet stock having apertures 52 therein, according to standard material available in the art. The retainer layer 50 is preferably 0.050″ thick and is composed of aluminum. It is preferred that the retainer layer 50 replace the perforated layer 20C of FIGS. 1 through 2B in order to limit the overall number of layers to six. Alternatively, however, the retainer layer 50 can be assembled over top of the perforated layer 20C and fastened within the hem 44 of FIGS. 2A and 2B with the rest of the layers.

Referring generally to FIGS. 1 through 3, the retainer layer 50 is utilized primarily in applications where the multilayer foil insulation 10 has a surface area so large that excessive ballooning necessarily occurs during operating conditions. Excessive ballooning tends to result in one or more of the layers of the multilayer foil insulation 10 coming into contact with a heat source and thereby disintegrating. It is anticipated that most products made of the multilayer foil insulation 10 will not have a large surface area and, thus, will not experience excessive the ballooning problem. In those applications where such a problem could potentially occur, the relatively thicker and more rigid retainer layer 50 is used and acts to cage in the other layers 20A through 20D, and 30 to prevent them from ballooning outward into contact with an adjacent heat source. Finally, the apertures 52 of the retainer layer 50 will permit sound and air to reach the first layer 20A, to ensure performance of the multilayer foil insulation 10 as described previously.

From the above, it can be appreciated that a significant advantage of the present invention is that the multilayer insulation not only successfully insulates a vehicle compartment from radiant heat, but also insulates the vehicle compartment from resonant sound by attenuating the sound via acoustic scattering and absorption.

An additional advantage is that the multilayer foil insulation insulates at least as well as prior art devices, but uses only six layers of foil using only three different thickness therefor, to achieve similar insulative capability as devices of the prior art.

A further advantage is that the perforations and associated standoffs are multipurpose features to provide unprecedented minimal surface contact between layers of the multilayer foil insulation, to provide more rigidity than embossments of the prior art, and to ventilate the multilayer foil insulation for preventing ballooning thereof.

While the present invention has been described in terms of a preferred embodiment, it is apparent that other forms could be adopted by one skilled in the art. In general, a multilayer foil insulation is provided for automotive heat shields requiring sound absorption qualities. While the present invention has been described in detail with respect to automotive exhaust applications of such multilayer foil insulation, the present invention is also well suited to other applications where heat and/or sound insulating properties are sought. Accordingly, the scope of the present invention is to be limited only by the following claims.

What is claimed is:

1. A multilayer insulation for dissipating heat and attenuating sound, said multilayer insulation comprising:
a plurality of layers stacked one upon another in a spaced apart relationship, said plurality of layers comprising at least one perforated layer having a plurality of perforations formed therein, said plurality of perforations defining a plurality of standoffs extending from said at least one perforated layer, said plurality of standoffs being in contact with an adjacent one of said plurality of layers thereby defining insulating spaces therebetween and maintaining said spaced apart relationship.

2. The multilayer insulation as claimed in claim 1, said plurality of layers comprises an imperforate layer adjacent said at least one perforated layer.

3. The multilayer insulation as claimed in claim 2, said plurality of perforations permit heat and sound to enter said multilayer insulation, said plurality of perforations acoustically scatter the sound, and said at least one imperforate layer acoustically absorbs the sound within said multilayer insulation, and such that said plurality of perforated layers and said insulating spaces therebetween enable heat dissipation and insulation.

4. The multilayer insulation as claimed in claim 3, wherein said imperforate layer is sandwiched between two perforated layers of said at least one perforated layer.

5. The multilayer insulation as claimed in claim 2, wherein said plurality of layers has a peripheral margin therearound.

6. The multilayer insulation as claimed in claim 5, further comprising a carrier layer having a peripheral crimping area thereon, said peripheral crimping area of said carrier layer being crimped over said peripheral margin of said plurality of layers to form a hem for assembling said multilayer insulation.

7. The multilayer insulation as claimed in claim 2, wherein each layer of said at least one perforated layer is composed of a metal foil 0.05 mm in thickness and said at least one imperforate layer is composed of a metal foil 0.025 mm in thickness.

8. The multilayer insulation as claimed in claim 7, wherein said metal foil is composed of aluminum.

9. The multilayer insulation as claimed in claim 2, wherein said plurality of layers are spaced from one another by approximately 0.25 to 1.75 millimeters.

10. The multilayer insulation as claimed in claim 1, wherein said plurality of perforations comprises slots.

11. The multilayer insulation as claimed in claim 10, wherein said slots of adjacent layers of said plurality of layers overlap and extend transversely to each other, so as to be in communication with one another.

12. The multilayer insulation as claimed in claim 11, wherein said slots are sized approximately one millimeter by two millimeters.

13. The multilayer insulation as claimed in claim 1, wherein said plurality of layers are from two to twenty-five in number.

14. The multilayer insulation as claimed in claim 1, wherein said plurality of layers comprises an expanded metal layer for retaining the rest of said plurality of layers.

15. A multilayer foil insulation for dissipating heat and attenuating sound, said insulation comprising:
an imperforate layer having opposite sides;
a first perforated layer being in contact with one of said opposite sides of said imperforate layer; and
a second perforated layer in contact with the other of said opposite sides of said imperforate layer such that said first and second perforated layers sandwich said imperforate layer in intimate contact therebetween; and
each of said first and second perforated layers comprising a plurality of perforations formed therein, said plurality of perforations defining a plurality of standoffs extending from each of said first and second perforated layers in at least a direction toward said imperforate layer, at least a portion of said plurality of standoffs further being in contact with said imperforate layer to space said first and second perforated layers away from said imperforate layer to form insulating spaces therebetween, whereby said plurality of perforations permit heat and sound to enter said multilayer foil insulation, and said imperforate layer acoustically absorbs sound within said multilayer insulation, and further whereby said plurality of perforated layers and said insulating spaces therebetween enable heat dissipation and insulation.

16. The multilayer foil insulation as claimed in claim 15, further comprising:
a third perforated layer in contact with said first perforated layer such that said first perforated layer is interposed said third perforated layer and said imperforate layer; and
a fourth perforated layer in contact with said second perforated layer such that said second perforated layer is interposed said fourth perforated layer and said imperforate layer;
said third and fourth perforated layers each having a plurality of perforations formed therein, said plurality of perforations defining a plurality of standoffs extending therefrom toward said first and second perforated layers and being in contact with said first and second perforated layers to space said first and third perforated layers away from each other and to space said second and fourth perforated layers away from each other, said plurality of perforations overlapping and extending transversely to each other.

17. The multilayer foil insulation as claimed in claim 16, wherein said imperforate layer and said first, second, third, and fourth perforated layers include a peripheral margin, said multilayer foil insulation further comprising a carrier layer having a peripheral crimping area thereon, said peripheral crimping area of said carrier layer being crimped over said peripheral margin of said imperforate layer and said first, second, third, and fourth perforated layers to form a hem for assembling said multilayer foil insulation together.

18. The multilayer foil insulation as claimed in claim 17, further comprising an adhesive applied around said peripheral margin to assist in retaining said multilayer insulation together.

19. A method of manufacturing a multilayer insulation, said method comprising the steps of:
providing a plurality of layers, at least one of said plurality of layers being a perforated layer having a plurality of perforations therein defining a plurality of standoffs extending in at least one direction from said perforated layer, at least one of said plurality of layers being a imperforate layer;
stacking said plurality of layers in a spaced apart relationship such that said plurality of standoffs contact an adjacent one of said plurality of layers thereby defining insulating spaces therebetween and maintaining said spaced apart relationship; and
die-cutting said plurality of layers into a stack of predetermined peripheral shape, said stack having a peripheral margin therearound.

20. The method as claimed in claim 19, further comprising the steps of:
providing a carrier layer having a peripheral crimping area thereon;
assembling said stack onto said carrier layer;
folding said peripheral crimping area of said carrier layer over said peripheral margin of said stack to crimp said stack to said carrier layer, thus forming a hem to retain said multilayer foil insulation together.

21. The method as claimed in claim 20, further comprising the step of applying adhesive between said peripheral crimping area of said carrier layer and said peripheral margin of said stack.
